(19) United States
(12) Patent Application Publication
(10) Pub. No.: US 2017/0323315 A1
(43) Pub. Date: Nov. 9, 2017

(54) INFORMATION COLLECTING APPARATUS AND INFORMATION COLLECTING METHOD

(71) Applicant: TOSHIBA TEC KABUSHIKI KAISHA, Tokyo (JP)

(72) Inventors: Tomonori Ikumi, Numazu Shizuoka (JP); Naoki Watanabe, Adachi Tokyo (JP); Masami Takahata, Setagaya Tokyo (JP)

(21) Appl. No.: 15/492,186

(22) Filed: Apr. 20, 2017

(30) Foreign Application Priority Data
May 9, 2016 (JP) 2016-093958

(51) Int. Cl. G06Q 30/02

(52) U.S. Cl. CPC G06Q 30/0203

(57) ABSTRACT

According to one embodiment, an information collecting apparatus outputs a question asking for an answer with a commodity to an output device of a user terminal. The information collecting apparatus detects a commodity which is input as an answer to the question from an input device of the user terminal. The information collecting apparatus acquires information on the detected commodity in association with information specifying a user of the user terminal.

### CROSS-REFERENCE TO RELATED APPLICATIONS

This application is based upon and claims the benefit of priority from Japanese Patent Application No. 2016-093958, filed May 9, 2016, the entire contents of which are incorporated herein by reference.

### FIELD

Embodiments described herein relate generally to an apparatus that collects information on thinking of shoppers and a method of causing a computer to function as the information collecting apparatus.

### BACKGROUND

In the related art, action data of a shopper is useful information for the marketing at a store (activities to raise sales) . For example, if a shopper stays at a specific sales floor, it can be estimated that the shopper is interested in commodities being sold at the sales floor. If the commodity in the sales floor is not included in the commodities that the shopper actually purchases, it can be analyzed that commodities attractive to the shopper are not available. A system for collecting such action data is already known.

However, the information collected in the current system is information that is estimated from the behavior of the shopper, and does not directly lead to thinking of shoppers. It is considered that more accurate marketing can be realized by collecting information based on thinking of shoppers.

### DESCRIPTION OF THE DRAWINGS

FIG. 1 is a block diagram illustrating a store system which is an embodiment.

FIG. 2 is a schematic diagram illustrating an area structure of a respondent memory.

FIG. 3 is a flowchart illustrating a procedure of a start process executed by a processor of a support server, based on a server program.

FIG. 4 is a flowchart illustrating a procedure of a thinking collection support process executed by the processor of the support server, based on the server program.

FIG. 5 is a flowchart illustrating a procedure of an answer evaluation process executed by the processor of the support server, based on the server program.

### DETAILED DESCRIPTION

An object of an exemplary embodiment to solve problems is to provide an information collecting apparatus capable of easily collecting information based on thinking of shoppers.

In general, according to one embodiment, an information collecting apparatus includes output means, detection means, and acquiring means. The output means outputs a question asking for an answer with a commodity to an output device of a user terminal. The detection means detects a commodity which is input as an answer to the question from an input device of the user terminal. The acquiring means acquires information on the commodity detected by the detection means in association with information specifying a user of the user terminal. Hereinafter, an embodiment of an information collecting apparatus capable of easily collecting information based on thinking of shoppers will be described with reference to the drawings.

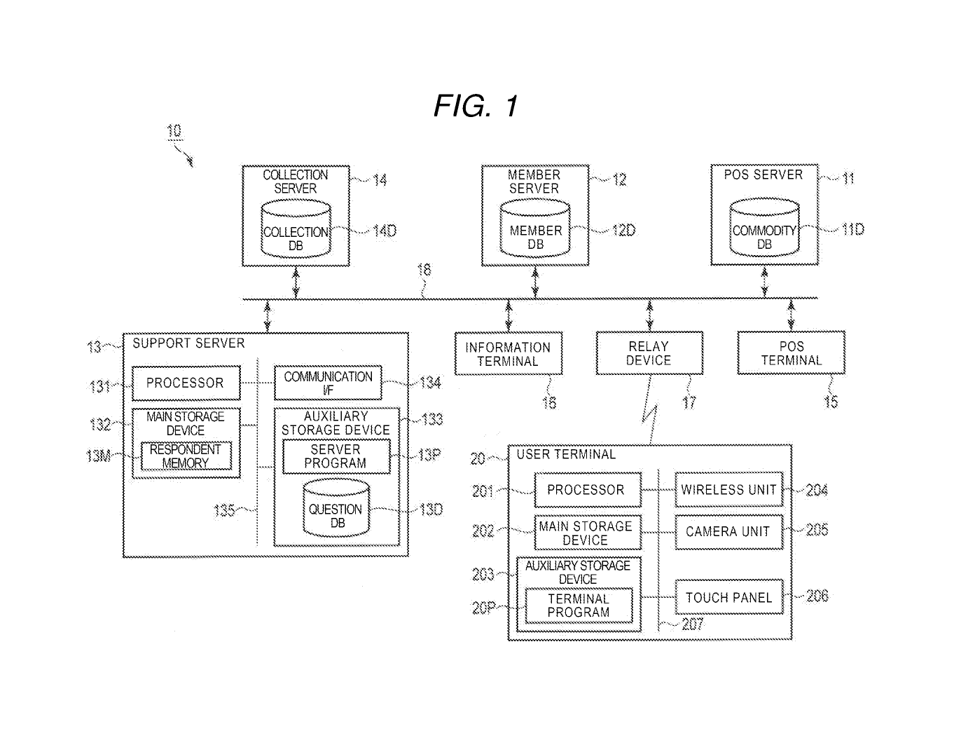

FIG. 1 is a block diagram illustrating an example of a store system 10 constructed in an existing store such as a supermarket. As illustrated, the store system 10 includes a Point Of Sales (POS) server 11, a member server 12, a support server 13, a collection server 14, a POS terminal 15, an information terminal 16, and a relay device 17. The store system 10 is constructed by connecting these devices with a network 18 such as a Local Area Network (LAN). The network 18 may be, for example, a wired LAN or a wireless LAN. The relay device 17 performs data communication with a user terminal 20 owned by the shopper in a wireless manner.

The store system 10 having such a configuration allows the shopper to execute self-registration by which the shopper can register data of purchasing commodities by himself or herself by operating the user terminal 20. Since the shopper registers data of purchasing commodity by himself or herself, it is possible to simplify the purchasing commodity registration operation at the POS terminal 15. In addition, the store system can execute an event that enables the collection of information based on the thinking of a shopper who operates the user terminal 20. The information based on thinking is information about a commodity that the shopper estimates for a question such as “What drink do you want to drink when thirsty?”. The shopper estimates a plurality of commodities for such a question. The store system 10 makes it possible to collect information on the commodity and the order that the shopper estimates for a question, that is, information based on thinking, in a quiz format event. The information collected by the store system 10 can be utilized as information useful for marketing by being classified and analyzed into each customer layer according to the gender, age, or the like of the shopper, for example. Therefore, the store system 10 has a mechanism that gives specific incentives to shoppers who have participated in quiz events such that the shoppers can actively participate in quiz format events, so-called quiz events.

Each of the servers 11, 12, 13, and 14 is installed in, for example, a store office. The installation location of each of the servers 11, 12, 13, and 14 is not particularly limited, if data communication with the POS terminal 15, the information terminal 16, and the relay device 17 is possible. Each of the servers 11, 12, 13, and 14 may be installed at any location outside the store. For example, each of the servers 11, 12, 13, and 14 may be installed as a cloud computer on the Internet.

The POS terminal 15 is installed, for example, at the accounting area (cash register) of a store. The POS terminal 15 registers the sales data of the commodity purchased by the shopper (purchasing commodity) in the memory. With the registration process, the price of the purchasing commodity is calculated. The POS terminal 15 performs a settlement process for settling the price of the purchasing commodity. The settlement process includes a settlement process for cash payment, a settlement process for credit payment, and the like. Since the registration process and the settlement process are well known processes at the POS terminal 15, a detailed description thereof will be omitted.

Incidentally, the POS terminal 15 is usually operated by a store staff called a cashier. The POS terminal 15 may be a self-type operated by the shopper himself/herself. A semi-self format may be used in which a registration unit that performs the registration process and a settlement unit that performs the settlement process are separated, the registration unit may be operated by the store staff, and the settlement unit may be operated by the shopper.

The information terminal 16 is installed, for example, near the sales floor or the gateway of the store. The information terminal 16 includes a touch panel as a man-machine interface (I/F), and is used by the shopper to obtain necessary service information. The information terminal 16 includes a scanner for reading barcodes. The information terminal 16 may be equipped with a printer.

The relay device 17 is installed, for example, in the sales floor of a store. The relay device 17 establishes a wireless communication network with the user terminal 20 possessed by the shopper purchasing a commodity in the sales floor. Then, the relay device 17 receives a wireless data signal transmitted from the user terminal 20, and transmits the signal to one of the servers 11, 12, 13, and 14 through the network 18. The relay device 17 converts the data signal addressed to the user terminal 20 received from one of the servers 11, 12, 13, and 14 into a wireless data signal, and transmits the data signal to the destination user terminal 20.

The user terminal 20 is a computer device having a wireless communication function. A shopper carries and uses the user terminal 20 when purchasing commodities at a store. For example, a smartphone, a tablet terminal, a mobile phone, and the like can be used as the user terminal 20.

In FIG. 1, each of the POS terminal 15, the information terminal 16, and the relay device 17 is illustrated as one, but these are not limited to one. Typically, two or more POS terminals 15, information terminals 16 and relay devices 17 are connected to the network 18 to construct the store system 10. Further, each user terminal 20 is owned by each shopper. This enables the relay device 17 to simultaneously relay wireless data signals to and from a plurality of user terminals 20.

The POS server 11 includes a commodity database (commodity DB) 11D. The commodity database 11D is stored in the auxiliary storage device of the POS server 11.

The commodity database 11D stores commodity record generated for each commodity. The POS server 11 accesses the commodity database 11D to read or write commodity records.

The commodity record includes data items such as a commodity ID, a classification ID, a commodity name, and unit price. The commodity ID is a unique code assigned to each commodity to identify each commodity. The classification ID is a unique code assigned to each classification to identify the classification of the commodity. In the case of food, the classification includes “cereals”, “beans”, “meat”, “fish”, “seaweeds”, “vegetables”, “fruits”, “mushrooms”, and “dairy commodities”. The commodity name is the name of the commodity identified by the corresponding commodity ID. The unit price is the price per item of the same commodity.

The member server 12 includes a member database (member DB) 12D. The member database 12D is stored in the auxiliary storage device of the member server 12.

The member database 12D stores the member records generated for each member. The member server 12 accesses the member database 12D and reads or writes the member record.

The member record includes data items such as member ID, personal information, and customer layer classification. The member ID is a unique code assigned to each member to identify each member individually. Personal information is the member name, gender, age, or the like of the member identified by the corresponding member ID. The customer layer classification is information specifying the customer layers that are classified from the gender and age of the same member. The customer layers are divided for each gender, for example, into teenagers or younger, 20s, 30s, 40s, 50s, and 60s or older, and a unique customer layer classification is assigned to each layer.

The support server 13 includes a processor 131, a main storage device 132, an auxiliary storage device 133, a communication I/F134, or the like. The processor 131, the main storage device 132, the auxiliary storage device 133, and the communication I/F134 are connected by a system transmission path 135 including an address bus, a data bus, and a control signal line.

The support server 13 constitutes a computer by the processor 131, the main storage device 132, and the auxiliary storage device 133, and the system transmission path 135 connecting them.

The processor 131 corresponds to the central portion of the computer. The processor 131 controls each unit to realize various functions as the support server 13, according to an operating system and an application program. The main storage device 132 corresponds to the main memory portion of the computer. The main storage device 132 includes a nonvolatile memory area (ROM: Read Only Memory) and a volatile memory area (RAM: Random Access Memory).

The main storage device 132 stores the operating system and the application program in the nonvolatile memory area. In some cases, the main storage device 132 stores data necessary for the processor 131 to execute processing for controlling each unit in a nonvolatile or volatile memory area. Further, the main storage device 132 uses the volatile memory area as a work area to which the data is appropriately written by the processor 131.

The auxiliary storage device 133 corresponds to the auxiliary storage portion of the above-described computer. The auxiliary storage device 133 stores the data used by the processor 131 to perform various processes and the data generated by the process performed by the processor 131. The auxiliary storage device 133 may also store the above-mentioned application program.

The communication I/F 134 is an interface for data communication through the network 18.

Since the support server 13 having such a configuration functions as an information collecting apparatus collecting the information based on thinking of shoppers, the auxiliary storage device 133 stores a server program 13P and a question database (question DB) 13D, and an area for the respondent memory 13M is reserved in the main storage device 132. The respondent memory 13M is provided in the volatile memory area.

The server program 13P is a resident program. When the support server 13 is in the normal operating state, the server program 13P is always executed by the processor 131. The server program 13P, in cooperation with the user terminal 20 operating based on the terminal program 20P described later, shows the processing procedure for controlling the processor 131 so that the support server 13 collects information based on thinking of shoppers.

The question database 13D stores the question records generated for each question. The processor 131 accesses the question database 13D and reads or writes the question record.

The purpose of the question is to collect information based on thinking of shoppers. Specifically, for example, a question asking a respondent to answer with a commodity is prepared, such as “What drink do you want to drink when thirsty?”. A specific beverage commodity is the correct answer to such a question.

The question record includes data items such as a question number, question data, and correct answer data. The question number is serial numbers assigned sequentially from “1” to each question. The question data is text data of the question specified by the corresponding question number. The correct answer data is the commodity ID of the commodity which is set as the correct answer to the question.

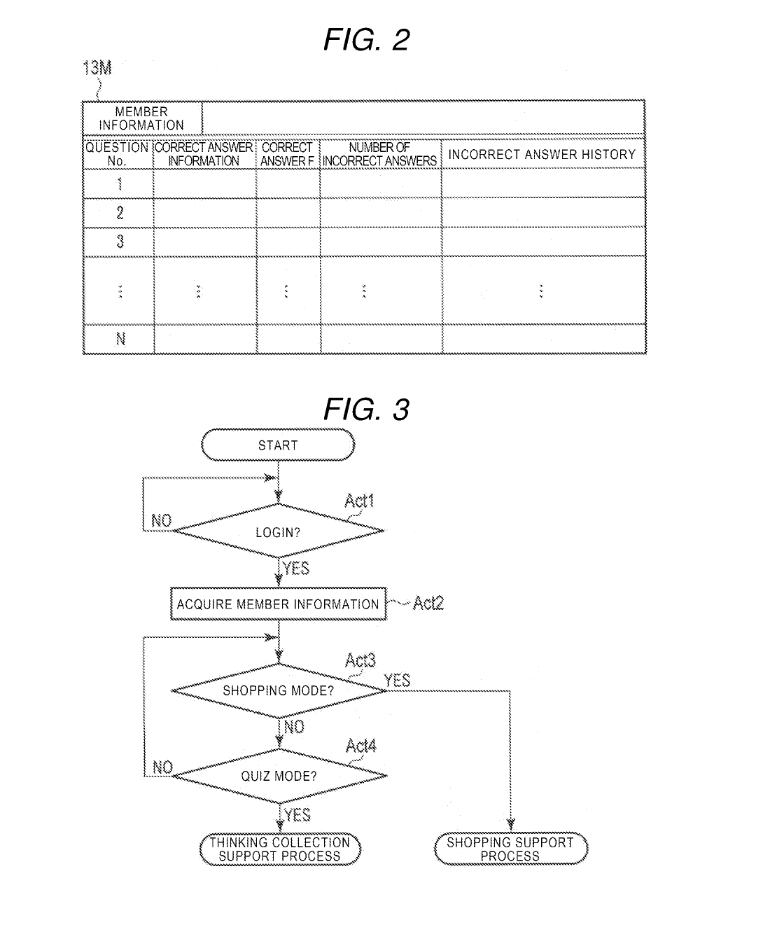

The respondent memory 13M has an area structure illustrated in FIG. 2. In other words, the respondent memory 13M includes a member information area and each area of the correct answer information, the correct answer flag, the number of incorrect answers, and the incorrect answer history for each question number. In the member information area, the member information of the respondent is stored. The shopper who participates in the quiz event becomes the respondent. All the data items of the member information need not to be stored in the member information area. At least the member ID and the customer layer classification may be stored. The correct answer data to the question specified by the corresponding question number is stored in the correct answer information area. A 1-bit flag (hereinafter referred to as a correct answer flag) of which default value is “0” and is updated to “1” when the answer is correct is stored in the correct answer flag area. The number of answers that the respondent answers incorrectly to the corresponding question is stored in the incorrect answer number area. The commodity IDs of the commodities that the respondent answers incorrectly are stored in the incorrect answer history area in order of answers.

The collection server 14 includes a collection database (collection DB) 14D. The collection database 14D is stored in the auxiliary storage device of the collection server 14.

The collection database 14D stores the data records of the respondent memory 13M generated by the support server 13. The collection server 14 collects the data record of the respondent memory 13M generated by the support server 13 through the network 18 and writes it into the collection database 14D.

The user terminal 20 includes a processor 201, a main storage device 202, an auxiliary storage device 203, a wireless unit 204, a camera unit 205, a touch panel 206, and the like. The processor 201, the main storage device 202, the auxiliary storage device 203, the wireless unit 204, camera unit 205 and the touch panel 206 are connected by a system transmission path 207 including an address bus, a data bus, and a control signal line.

The user terminal 20 constitutes a computer by the processor 201, the main storage device 202, the auxiliary storage device 203, the wireless unit 204, the camera unit 205, and the touch panel 206 and the system transmission path 207 by which these are connected.

The processor 201 corresponds to the central portion of the above-mentioned computer. The processor 201 controls each unit to realize various functions as the user terminal 20, according to an operating system and an application program.

The main storage device 202 corresponds to the main memory portion of the computer. The main storage device 202 includes a non-volatile memory area (ROM) and a volatile memory area (RAM) . The main storage device 202 stores the operating system and the application program in the nonvolatile memory area. In some cases, the main storage device 202 stores data necessary for the processor 201 to execute processing for controlling each unit in a nonvolatile or volatile memory area. In addition, the main storage device 202 uses the volatile memory area as a work area into which data is appropriately written by the processor 201.

The auxiliary storage device 203 corresponds to the auxiliary storage portion of the above-described computer. The auxiliary storage device 203 stores the data used by the processor 201 to perform various processes and the data generated by the process performed by the processor 201. The auxiliary storage device 203 may also store the above-mentioned application program.

The wireless unit 204 includes a wireless circuit that transmits and receives data to and from the relay device 17 by using wireless communication. The camera unit 205 includes a camera device having a resolution capable of capturing images of barcodes. The touch panel 206 functions as an input device and a display device of the user terminal 20. The touch panel 206 displays an icon for activating the application program.

If the terminal program 20P is installed, the user terminal 20 having such a configuration becomes a corresponding device for the self-registration and the quiz event using the store system 10. The terminal program 20P shows the procedure for controlling the processor 201 in order to operate the user terminal 20 as a corresponding device for the self-registration and the quiz event. The terminal program 20P is stored in the auxiliary storage device 203.

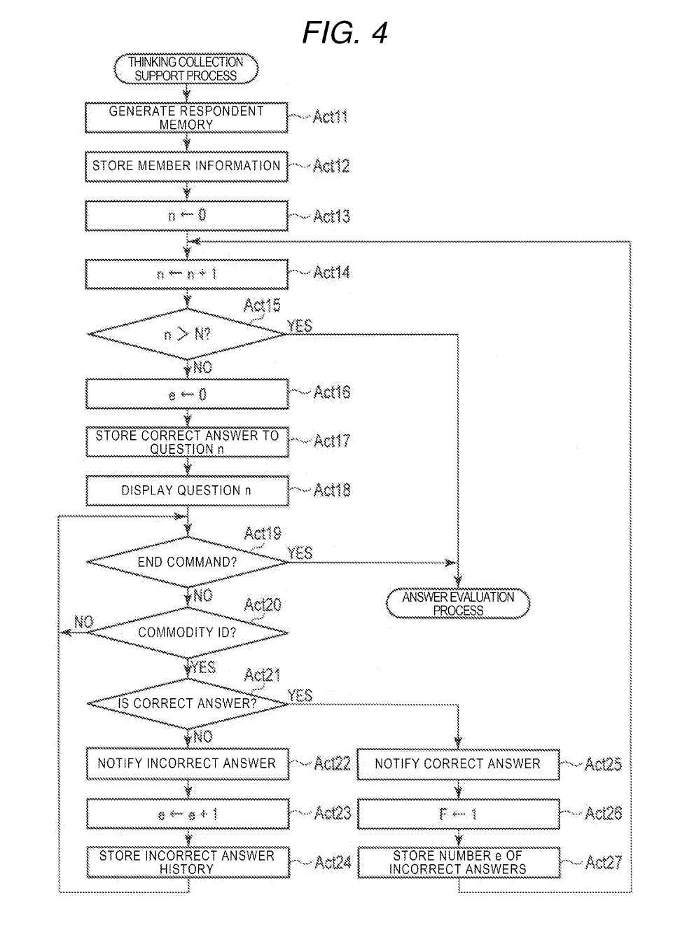

FIGS. 3 to 5 are flowcharts illustrating the main processing procedures performed by the processor 131 of the support server 13 with the user terminal 20 in which the terminal program 20P is installed, based on the server program 13P. Hereinafter, the main operations of the store system 10 will be described with reference to FIGS. 3 to 5. In addition, the contents of processes to be described later illustrated in the flowcharts of FIGS. 3 to 5 are an example, and various processes capable of obtaining the same result can be used as appropriate.

The shopper who has visited the store touches the icon of the terminal program 20P displayed on the touch panel 206 of the user terminal 20 and instructs the start of the terminal program 20P. When the terminal program 20P is started, a login screen is displayed on the touch panel 206, and thus the shopper logs in using the member ID. After logging in, login authentication is performed at the member server 12. The authentication result is notified to the user terminal 20. When the login is approved, a mode selection screen is displayed on the touch panel 206. The mode selection screen is a screen prompting the shopper to select one of a shopping mode and a quiz mode. The shopper who registers the data of the purchasing commodity by himself selects the shopping mode. The shopper who participates in a quiz event selects the quiz mode.

The processor 131 of the support server 13 in which the server program 13P is resident is waiting for the login of the shopper to be approved, as Act1. When it is detected that the login of the shopper is approved by the notification from the member server 12 (YES in Act1), the processor 131 acquires the member information of the shopper as Act2. In other words, the processor 131 accesses the member server 12 and requests the member record specified by the member ID entered at login. In response to this request, the processer of the member server 12 reads the corresponding member record from the member database 12D and sends it to the support server 13 through the network 18. The processor 131 of the support server 13 obtains member information such as a member ID, personal information, and customer layer classification from the member record. Then, the processor 131 stores the member information in the work area of the main storage device 132.

The processor 131 that has obtained the member information checks whether or not the shopping mode is selected in the user terminal 20 of which login of the shopper is approved, as Act3. If the shopping mode is not selected (NO in Act3), the processor 131 checks whether or not the quiz mode is selected (Act4). If the quiz mode is not selected (NO in Act4), the processor 131 returns to the process of Act3. Here, the processor 131 waits for the selection of the shopping mode or the quiz mode by the processes of Act3 and Act4.

If the shopping mode is selected (YES in Act3), the processor 131 executes a shopping support process. When the quiz mode is selected (YES in Act4), the processor 131 executes a thinking collection support process.

First, the shopping support process will be described. The shopper who has selected the shopping mode captures the image of the barcode of a commodity wanted to be purchased, a so-called a purchasing commodity, with the camera unit 205 of the user terminal 20, and puts the commodity in the shopping cart or the like. If the image of the barcode of the purchasing commodity is captured by the camera unit 205, the processor 201 of the user terminal 20 controls the wireless unit 204 so as to transmit the barcode data to the support server 13. By this control, the barcode data is wirelessly transmitted from the user terminal 20 to the support server 13. The member ID (hereinafter referred to as “member IDx”) entered at the time of login authentication is added to the barcode data.

When the shopping support process is started, the processor 131 of the support server 13 generates a user memory for the member IDx in the main storage device 132. In the user memory, member information of the member IDx is stored from the work area.

The processor 131 waits for barcode data to be wirelessly transmitted from the user terminal 20. Then, each time the barcode data is received through the communication interface 134, the processor 131 analyzes the barcode data. When the commodity ID is detected from the barcode data, the processor 131 accesses the POS server 11 and requests a commodity record including the commodity ID. In response to this request, the processor of the POS server 11 reads the corresponding commodity record from the commodity database 11D and sends it to the support server 13. Upon receiving the commodity record through the communication interface 134, the processor 131 of the support server 13 acquires commodity information such as the commodity ID, the classification ID, the commodity name, and the unit price from the commodity record. Then, the processor 131 stores this commodity information in the user memory for the member IDx. The processor 131 transmits a data signal for controlling the user terminal 20 to the user terminal 20 such that for example, the commodity name and the unit price of the commodity information are displayed on the touch panel 206. Upon receiving the data signal, the touch panel 206 of the user terminal 20 displays the commodity name and the unit price of the commodity of which the image of the barcode is captured by the camera unit 205.

The shopper who has finished the purchase moves to the accounting area (cash register) where the POS terminal 15 is installed. The POS terminal 15 has a barcode indicating a unique POSID. A shopper or a store staff who is in charge of accounting captures an image of a barcode indicating the POSID, with the camera unit of the user terminal 20. Even when the image of POSID barcode is captured by the camera unit 205, the processor 201 of the user terminal 20 controls the wireless unit 204 so as to transmit the barcode data to the support server 13. By this control, the barcode data is wirelessly transmitted from the user terminal 20 to the support server 13. The member IDx is also added to the barcode data.

When the POSID is detected from the barcode data received through the communication interface 134, the processor 131 of the support server 13 reads the commodity information stored in the user memory for a member IDx. Then, the processor 131 controls the communication interface 134 so as to transmit the commodity information to the POS terminal 15 specified by the POSID. By this control, the commodity information stored in the user memory for the member IDx is collectively transmitted from the support server 13 to the POS terminal 15.

The processor of the POS terminal 15 registers sales data of the purchasing commodity in the memory based on the commodity information received from the support server 13. Since the price of the purchasing commodity is calculated by the registration process, the shopper pays the price. Upon receiving the payment of the price, the processor of the POS terminal 15 executes the settlement process.

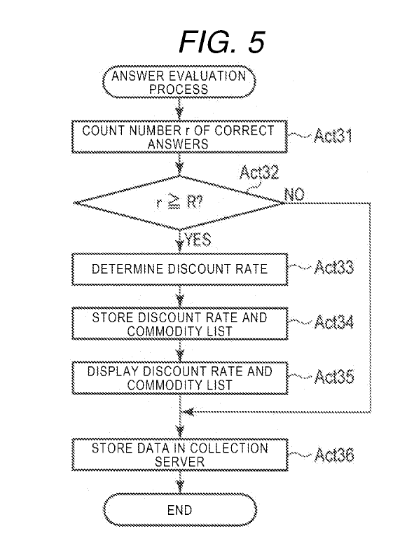

Next, the thinking collection support process will be described with reference to FIGS. 4 and 5.

When the processor 131 of the support server 13 starts the thinking collection support process, it generates the respondent memory 13M for the member IDx in the main storage device 132 as Actll. The member information of the member IDx is stored in the respondent memory 13M from the work area. All the data items of the member information may not be stored in the respondent memory 13M. At least the member ID and the customer layer classification may be stored in the respondent memory 13M.

The processor 131 resets the question number counter n to “0” as Act13. The question number counter n is formed, for example, in the volatile memory area of the main storage device 132. The processor 131 counts up the question number counter n by “1” as Act14. Then, the processor 131 determines whether or not the question number counter n exceeds the number of questions N as Act15. The number of questions N is the total number of question records set in the question database 13D. The number of questions N is stored in the auxiliary storage device 133 in advance, for example.

When the question number counter n does not exceed the number of questions N (NO in Act15), the processor 131 initializes the incorrect answer number counter e to “0” as Act16. The incorrect answer number counter e is formed, for example, in the volatile memory area of the main storage device 132. In addition, the processor 131 reads the question records of the question number n from the question database 13D. The question number n is the count value of the question number counter n. After reading the question record of the question number n, the processor 131 sets the correct answer data of the question record in the correct answer information area corresponding to the question number n in the respondent memory 13M for the member IDx, as Act17. The processor 131 transmits a data signal for controlling the user terminal 20 to the user terminal 20 such that the question of the question data included in the question record is displayed on the touch panel 206, as Act18. Upon receiving the data signal, a question is displayed on the touch panel 206 of the user terminal 20. Here, the processor 131 constitutes an output unit that outputs a question asking for an answer with a commodity to the touch panel 206 (output device) of the user terminal 20.

If a question is displayed on the touch panel 206, a shopper who chooses the quiz mode (hereinafter referred to as a respondent) estimates a commodity to be a correct answer. Then, the respondent searches for the estimated commodity in the store, and captures the image of the barcode attached to the commodity, with the camera unit 205 of the user terminal 20. An end icon for instructing the end of the event as well as the question is also displayed on the touch panel 206. When stopping participation in the quiz event, the respondent touches the end icon.

If the barcode of the commodity is captured by the camera unit 205, the processor 201 of the user terminal 20 controls the wireless unit 204 so as to transmit the barcode data to the support server 13. By this control, the barcode data is wirelessly transmitted from the user terminal 20 to the support server 13. The member IDx is also added to the barcode data. On the other hand, when the end icon is touched, the processor 201 controls the wireless unit 204 so as to transmit the end command to the support server 13. By this control, an end command is wirelessly transmitted from the user terminal 20 to the support server 13. The member IDx is also added to the end command.

The processor 131 of the support server 13 checks whether or not an end command is received, as Act19. If the end command is not received (NO in Act19), the processor 131 checks whether or not a commodity ID is received, as Act20. If the commodity ID is not received (NO in Act20), the processor 131 returns to the process of Act19. Thus, the processor 131 waits to receive the end command or the commodity ID through the processes of Act 19 and Act20.

As a result of analyzing the barcode data received through the communication interface 134, if the commodity ID is detected, the processor 131 recognizes that the commodity ID is received. Upon receiving the commodity ID (YES in Act20), the processor 131 checks whether or not the commodity identified by the commodity ID is a correct answer to the question, as Act21. In other words, the processor 131 reads correct answer information corresponding to the question number n from the respondent memory 13M for the member IDx. Then, the processor 131 compares the commodity ID of the correct answer information with the commodity ID obtained by analyzing the barcode data. As a result, if the two IDs match, the processor 131 determines that the answer is correct. If the two IDs do not match, the processor 131 determines that the answer is incorrect. Here, the processor 131 constitutes a detection unit that detects the commodity entered as an answer to the question from the camera unit 205 (input device) of the user terminal 20. The processor 131 also constitutes a determination unit that determines whether or not the commodity detected by the detection unit is a correct answer to the question.

If the answer is determined to be incorrect (NO in Act21), the processor 131 transmits a data signal for controlling the user terminal 20 so as to notify that the answer is incorrect to the user terminal 20, as Act22. Upon receiving the data signal, a message notifying that the answer is incorrect is displayed on the touch panel 206 of the user terminal 20. Incidentally, it maybe notified that the answer is incorrect by sound together with the message. Alternatively, it may be notified that the answer is incorrect only by sound.

If the answer is determined to be incorrect (NO in Act21), the processor 131 counts up the incorrect answer number counter e by “1”, as Act23. Then, the processor 131 stores incorrect answer history data as Act24. In other words, the processor 131 stores the commodity ID detected from the barcode data in association with the count value of the incorrect answer number counter e, in the incorrect answer history area corresponding to the question number n in the respondent memory 13M for the member IDx. Thereafter, the processor 131 returns to the process of Act19. Then, the process of Act19 and subsequent processes are executed in the same manner as above. Here, the processor 131 constitutes an acquiring unit that acquires information (commodity ID) on the commodity detected by the detection unit in association with information (member ID) specifying a user of the user terminal 20.

On the other hand, if the answer is determined to be correct (YES in Act20), the processor 131 transmits a data signal for controlling the user terminal 20 so as to notify that the answer is correct to the user terminal 20, as Act25. Upon receiving the data signal, a message notifying that the answer is correct is displayed on the touch panel 206 of the user terminal 20. In addition, it may be notified that the answer is correct by sound together with the message. Alternatively, it may be notified that the answer is correct only by sound.

If the answer is determined to be correct (YES in Act20), the processor 131 sets the correct answer flag F to “1” as Act26 and stores the number e of incorrect answers as Act27. In other words, the processor 131 changes the correct flag F in the flag area corresponding to the question number n in the respondent memory 13M for the member IDx from “0” to “1”. Further, the processor 131 stores the count value of the incorrect answer counter e, in the incorrect answer number area corresponding to the same question number n. Thereafter, the processor 131 returns to the process of Act14. Then, the process of Act14 and subsequent processes are executed in the same manner as above. Here, the processor 131 constitutes a termination unit that terminates the acquisition of the answer to the question if the answer is determined to be correct by the determination unit.

As described above, if the respondent captures the image of the barcode of the commodity estimated from the question, with the camera unit 205, it is notified whether or not the commodity is a correct answer. If the answer is incorrect, the question is not changed. The respondent captures the image of the barcode of another commodity estimated from the same question, with the camera unit 205. The operation is repeated until the respondent captures the image of the barcode of the commodity which is the correct answer, with the camera unit 205. If the image of the barcode of the commodity which is the correct answer is captured with the camera unit 205, the process moves to the next question. Even with respect to the question, the same operation is repeated until the respondent captures the image of the barcode of the commodity which is the correct answer, with the camera unit 205.

Thus, the number of incorrect answers and the incorrect answer history data until the respondent identified by the member IDx obtains the correct answer are stored for each question, in the respondent memory 13M for the member IDx. The incorrect answer history data is data in which the commodity IDs of the commodities that are incorrectly answered are accumulated in the incorrectly answered order.

If the count value n exceeds the number N of questions (YES in Act15) and the end command is received (YES in Act19), the processor 131 starts an answer evaluation process.

FIG. 5 is a flowchart specifically illustrating the procedure of the answer evaluation process. When the answer evaluation process is started, the processor 131 counts the number r of correct answers, as Act31. In other words, the processor 131 counts the number of correct answer flags F set to “1” out of the correct answer flags F for each question number stored in the respondent memory 13M for the member IDx. Then, the processor 131 sets this number as the number r of correct answers. Here, the processor 131 constitutes a counting unit that counts the number of times that the answer is determined to be correct by the determination unit.

If the number r of correct answers is counted, the processor 131 determines whether or not the number r of correct answers is equal to or larger than the determination value R of the incentive, as Act32. The determination value R is preset in the auxiliary storage device 133, for example. In the present embodiment, it is assumed that incentives for discount sales are given to respondents who have reached the determination value R with the number r of correct answers. By giving incentives for discount sales, many shoppers are considered to participate in quiz events.

When the number r of correct answers is equal to or larger than the determination value R (YES in Act32), the processor 131 determines the discount rate as Act33. For example, the support server 13 includes a discount rate table in which the number of correct answers and the discount rate are set in association with each other such that the discount rate increases as the number of correct answers increases. The discount rate table is stored in the auxiliary storage device 133, for example. The processor 131 searches the discount rate table and determines a discount rate according to the number r of correct answers.

After determining the discount rate, the processor 131 stores the discount rate and the list of commodities to be discounted in the user memory for the member IDx, as Act34. The commodity to be discounted is, for example, a commodity specified by the commodity ID stored as correct answer information of each question in the respondent memory 13M. The commodity to be discounted may be a commodity specified by the commodity ID stored as the incorrect answer history data. Alternatively, a commodity with a preset commodity ID may be a commodity to be discounted. Which commodity to be discounted is optional. As will be described later, a shopper identified by the member IDx can purchase at least one out of commodities to be discounted, at a price obtained by discounting at the discount rate stored in the user memory. Here, the processor 131 constitutes a giving unit that gives benefits to the user of the user terminal 20 according to the number of times counted by the counting unit.

When shoppers who are respondents select a shopping mode and start shopping before participating in a quiz event, that is, when shoppers participate in a quiz event in the middle of shopping, the user memory for the member IDx is formed in the main storage device 132 of the support server 13. However, for the respondent who participates in the quiz event before shopping, the user memory for the member IDx is not formed in the main storage device 132. In this case, the processor 131 generates a user memory for the member IDx in the main storage device 132, and stores the discount rate and the list of commodities to be discounted in the user memory.

After determining the discount rate, the processor 131 also transmits a data signal for controlling the user terminal 20 so as to display the discount rate and the list of commodities to be discounted on the touch panel 206 to the user terminal 20, as Act35. Upon receiving the data signal, the discount rate and the list of commodities to be discounted are displayed on the touch panel 206 of the user terminal 20. Therefore, the respondent can check the discount rate and the list of commodities to be discounted.

If the number r of correct answers is equal to or larger than the determination value R (YES in Act32), the processes of Act33 to Act35 are executed. Otherwise, if the number r of correct answers has not reached the determination value R (NO in Act32), the processor 131 stores the data stored in the respondent memory 13M for the member IDx, in the collection server 14. In other words, the processor 131 reads member information, and correct answer information, a correct answer flag, the number of incorrect answers, and incorrect answer history data in order of question numbers, from the respondent memory 13M for the member IDx. Then, the processor 131 generates a data record of the respondent memory 13M from these data, and controls the communication interface 134 so as to transmit the data record to the collection server 14. By this control, the data record of the respondent memory 13M is transmitted to the collection server 14 through the network 18 and stored in the collection database 14D. Here, the processor 131 constitutes a control unit that performs control so as to store the information acquired by the acquiring unit by using the respondent memory 13M.

As described above, the processor 131 ends the answer evaluation process.

Upon completion of the answer evaluation process, the processor 131 waits for the shopping mode to be selected in the user terminal 20 of which login with the member IDx is approved. If the shopping mode is selected, the processor 131 executes a shopping support process. In the shopping support process, if the commodity ID of the commodity to be discounted stored in the user memory for the member IDx is detected from the barcode data wirelessly transmitted from the user terminal 20, the processor 131 performs a discount process. In other words, the processor 131 changes the unit price of the commodity identified by the commodity ID to a price obtained by discounting at the discount rate, and performs the subsequent processes. The upper limit of the number of times of the discount process may be set in advance, and if the number of times of the change process reaches the upper limit, the discount process may not be performed.

As described above, according to the support server 13, a question asking for an answer with a commodity is displayed on the touch panel 206 of the user terminal 20 used by the shopper. Then, it is possible to acquire the history that the shopper answers to the question. This history is information on the commodity and the order that the shopper estimates for a question, that is, information based on thinking. Therefore, information based on thinking of shoppers can be easily collected.

Further, according to the support server 13, it is possible to acquire not only the answered history but also the number of answers up to the correct answer. For example, when the average of the number of answers is smaller compared to other questions, it is considered that many customers earlier estimate the commodity which is the correct answer to the questions. Therefore, the number of answers can also be collected as information based on thinking of shoppers.

Further, according to the support server 13, it is possible to give discount benefits to shoppers depending on the number of correct answers to the question. Therefore, since motivation of shoppers participating in quiz events increases, information based on thinking of many shoppers can be easily collected.

According to the support server 13, the information based on the thinking of a shopper acquired from the user terminal 20 can be accumulated and stored in the collection server 14. Therefore, it is possible to obtain useful information for marketing with higher accuracy by classifying and analyzing the information accumulated and stored by the collection server 14 into each customer layer according to the age, gender, or the like of the shopper, for example.

The present invention is not limited to the above embodiment.

For example, in the above embodiment, the correct answer to the question is predetermined, and when an answer is correct, information collection for the question is canceled. However, in this operation, if the shopper immediately answers the correct answer, there is concern that information on the commodity and the order that the shopper estimates for a question cannot be collected sufficiently. Therefore, an operation may be adopted in which the number of answers to the question may be counted and the answer is considered to be correct when the number of answers reaches a predetermined number (for example, 5) . In this case, it is preferable to randomly change the predetermined number of times.

In the above embodiment, it is assumed that the incentive given to the shopper participating in the quiz event is sold at the discount price, but the type of the incentive is not particularly limited. For example, it may be an incentive to give a prize depending on the number of correct answers.

One commodity is regarded as a correct answer to a question in the above embodiment, but two or more commodities may be correct answers. When two or more commodities are correct answers, it may be considered an operation of regarding as a correct answer when any one correct answer is obtained, and an operation of regarding as a correct answer only when all correct answers are obtained. Also, even for the same question, the correct answer may be changed depending on a customer layer, a time zone, or the like.

In the embodiment, even though the question is shared irrespective of the customer layer of a shopper (respondent), the question may be changed for each customer layer, for example, in such a manner that questions for male and question for women are prepared. In this case, customer layer information may be added to the question record.

In the above embodiment, the case of collecting information on thinking of shoppers in a real store is exemplified. For example, a personal computer, a smartphone or the like connected to the Internet is assumed to be the user terminal 20, and a shopper who operates the user terminal 20 accesses a virtual store on the Internet and answers the question, so that it is also possible to collect information on thinking of shoppers.

The transfer of the support server 13 which is the information collecting apparatus is generally performed in a state in which the server program 13P which is an information collecting program is stored in the auxiliary storage device 133. However, not limiting thereto, and the transfer may be performed in a state where the server program 13P is stored in the main storage device 132 of the support server 13. Alternatively, the server program 13P which is transferred separately from the computer apparatus may be written into the computer apparatus according to the operation of the user. The transfer of the server program 13P can be performed by recording it on a removable recording medium or by communication through a network. The recording medium may be in any form such as a CD-ROM, a memory card, or the like as long as it can store a program and is readable by an apparatus. In addition, the function obtained by installing or downloading a program may be realized in cooperation with an operating system (OS) or the like inside the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information collecting apparatus comprising:
a memory; and
a processor configured to execute components stored on the memory, the components comprising:
output means for outputting a question asking for an answer with a commodity to an output device of a user terminal;
detection means for detecting a commodity which is input as an answer to the question from an input device of the user terminal; and
acquiring means for acquiring information on the commodity detected by the detection means in association with information specifying a user of the user terminal.

2. The apparatus according to claim 1, the components further comprising:
determination means for determining whether or not the commodity detected by the detection means is a correct answer to the question; and
termination means for terminating the acquisition of the answer to the question if the answer is determined to be correct by the determination means.

3. The apparatus according to claim 2, the components further comprising:
counting means for counting a number of times that the answer is determined to be correct by the determination means; and
giving means for giving benefits to a user of the user terminal depending on the number of times.

4. The apparatus according to claim 1, the components further comprising:
control means for controlling whether the information acquired by the acquiring means is to be stored.

5. The apparatus according to claim 1, wherein the user terminal is a smartphone.

6. The apparatus according to claim 1, wherein the output means outputs the question asking for the answer to the output device of the user terminal wirelessly.

7. The apparatus according to claim 1, the components further comprising:
a question database comprising a plurality of questions from which to output to the output device of the user terminal.

8. An information collecting method implemented by a computer comprising an interface with a user terminal, the method comprising:
outputting a question asking for an answer with a commodity to an output device of the user terminal;
detecting a commodity which is input as an answer to the question from an input device of the user terminal; and
acquiring information on the detected commodity in association with information specifying a user of the user terminal.

9. The method according to claim 8, further comprising:
determining whether or not the commodity detected is a correct answer to the question; and
terminating acquisition of the answer to the question if the answer is determined to be correct.

10. The method according to claim 9, further comprising:
counting a number of times that the answer is determined to be correct; and
giving benefits to a user of the user terminal depending on the number of times.

11. The method according to claim 8, further comprising:
controlling whether the information acquired is to be stored.

12. The method according to claim 8, further comprising:
outputting wirelessly the question asking for the answer to the output device of the user terminal.

13. The method according to claim 8, further comprising:
outputting the question from a question database comprising a plurality of questions.

14. An information collecting system, comprising:
a memory; and
a processor configured to execute components stored on the memory, the components comprising:
an output component for outputting a question asking for an answer with a commodity to an output device of a user terminal;
a detector for detecting a commodity which is input as an answer to the question from an input device of the user terminal; and
an acquiring component for acquiring information on the commodity detected by the detector in association with information specifying a user of the user terminal.

15. The system according to claim 14, the components further comprising:
a determinator for determining whether or not the commodity detected by the detector is a correct answer to the question; and
a terminator for terminating the acquisition of the answer to the question if the answer is determined to be correct by the determinator.

16. The system according to claim 15, the components further comprising:
a counter for counting the number of times that the answer is determined to be correct by the determinator; and
a giving component for giving benefits to a user of the user terminal depending on the number of times.

17. The system according to claim 14, the components further comprising:
a controller for controlling whether the information acquired by the acquiring component is to be stored.

18. The system according to claim 14, wherein the user terminal is a smartphone.

19. The system according to claim 14, wherein the output component outputs the question asking for the answer to the output device of the user terminal wirelessly.

20. The system according to claim 14, the components further comprising:
a question database comprising a plurality of questions from which to output to the output device of the user terminal.
